(19) United States
(12) Patent Application Publication
(10) Pub. No.: US 2013/0155341 A1
(43) Pub. Date: Jun. 20, 2013

(54) TRANSFLECTIVE LCD PANEL

(71) Applicants: Xiaoxiong Tian, Beijing (CN); Jianshe Xue, Beijing (CN)

(72) Inventors: Xiaoxiong Tian, Beijing (CN); Jianshe Xue, Beijing (CN)

(73) Assignee: BOE TECHNOLOGY GROUP CO., LTD., Beijing (CN)

(21) Appl. No.: 13/703,801

(22) PCT Filed: Oct. 26, 2012
(86) PCT No.: PCT/CN12/83587

§ 371 Date: Dec. 12, 2012

(30) Foreign Application Priority Data
Dec. 14, 2011 (CN) 201110418596.3

(51) Int. Cl. G02F 1/1337; G02F 1/1335

(52) U.S. Cl. CPC G02F 1/1337; G02F 1/133555
USPC 349/42

(57) ABSTRACT

The present disclosure relates to a transflective LCD panel. A thin film transistor and a first insulating layer are formed on the side of a first transparent substrate facing a second transparent substrate, and the first insulating layer covers the thin film transistor; a transparent electrode layer and a reflective electrode layer are formed above the first insulating layer. A color filter layer is provided on the side of the second transparent substrate facing the first transparent substrate, and comprises a first color filter layer and a second color filter layer, the first color filter layer corresponds to the reflective electrode layer and the second color filter layer corresponds to the transparent electrode layer which is overlapped with the reflective electrode layer, and the color filtering ability of the first color filter layer is less than that of the second first color filter layer.

### FIELD

The embodiments of the present disclosure generally relates to a transflective liquid crystal display (LCD) panel.

### BACKGROUND

Generally, LCD may be categorized as transmissive LCD, reflective LCD and transflective LCD. Specifically, back light unit is employed in the transmissive LCD as a light source, which leads to a large amount of power consumption due to the fact that only 10% of lights from the back light unit is transmitted. Natural light is used in the reflective LCD as the light source with a very low power consumption, but such display may only be used in an environment with plenty of ambient lights, and thus is of little use in night time or in a dark environment without ambient lights. Transflective LCD is consequently developed to combine the advantages of both reflective LCD and transmissive LCD.

As shown in FIG. 1, in a conventional transflective LCD panel 100, a thin film transistor 103 is formed on a first glass substrate 101. A first insulating layer 104 is deposited on the first glass substrate 101 to cover the thin film transistor 103. A first contact hole 1041 is formed in the first insulating layer 104, and an indium tin oxide (ITO) transparent electrode layer 105 is formed on a part of the insulating layer 104 with one end of the ITO transparent electrode layer 105 is located in the first contact hole 1041 such that the ITO transparent electrode layer 105 is electrically connected to the drain 1031 of the thin film transistor 103 through the first contact hole 1041. In addition, as shown in FIG. 1, color saturation of the reflective region is different from that of the transmissive region due to the optical path difference in the reflective region and the transmissive region. In order to address the above issue, a second insulating layer 109 is thereby formed on a part of the first insulating layer 104, such that the second insulating layer 109 covers a part of the ITO transparent electrode layer 105 and is provided with a second contact hole 1091 corresponding to and connecting with the first contact hole 1041. An Al electrode layer 106 is formed on the second insulating layer 1091. The region with the Al electrode layer 106 provided thereon is thereby the reflective region R of the LCD panel, while the region with the ITO transparent electrode layer 105 provided thereon is the transmissive region T of the LCD panel. As shown in FIG. 1, the conventional transflective LCD panel 100 further comprises a second transparent substrate 102, a color filter layer 107 formed on the second transparent substrate 102, and a common electrode layer 108 formed on the color filter layer 107.

However, since the second contact hole 1091 is provided corresponding to and connecting with the first contact hole 1041, the hole depth H of the first contact hole 1041 and the second contact hole 1091 is thus relatively large. As such, during the alignment process of the alignment film on the Al electrode layer 106 and the ITO transparent electrode layer 105, the alignment induced by the alignment film may be non-uniform, which in turn introduce non-uniform orientation the liquid crystal molecules at corresponding locations with a height difference. In this case, when the LCD panel is set to a dark mode, a light leakage might occur to otherwise a full black image displayed by the LCD panel due to the non-uniform orientation of the liquid crystal molecules, leading to a decrease in the LCD panel contrast, thereby affecting product quality.

### SUMMARY

One embodiment of the present disclosure provides a transflective LCD panel comprising: a first transparent substrate and a second transparent substrate opposing with each other, and a liquid crystal layer provided between the first transparent substrate and the second transparent substrate. A thin film transistor and a first insulating layer are formed on the side of the first transparent substrate facing the second transparent substrate, and the first insulating layer covers the thin film transistor; a transparent electrode layer and a reflective electrode layer are formed above the first insulating layer, with the reflective layer and the transparent electrode layer substantially on a same level; A color filter layer is provided on the side of the second transparent substrate facing the first transparent substrate, and comprises a first color filter layer and a second color filter layer, the first color filter layer corresponds to the reflective electrode layer and the second color filter layer corresponds to the transparent electrode layer which is overlapped with the reflective electrode layer, and the color filtering ability of the first color filter layer is less than that of the second first color filter layer.

Another embodiment of the present disclosure provides a display apparatus, comprising the transflective LCD panel according to any of the above-mentioned embodiments.

### BRIEF DESCRIPTION OF THE DRAWINGS

The present invention will become more fully understood from the detailed description given hereinafter and the accompanying drawings which are given by way of illustration only, and thus are not limitative of the present invention.

FIG. 1 is a schematic view of a conventional transflective LCD panel; and

FIG. 2 is a schematic view of a transflective LCD panel according to embodiments of the present disclosure.

### DETAILED DESCRIPTION OF THE PREFERRED EMBODIMENTS

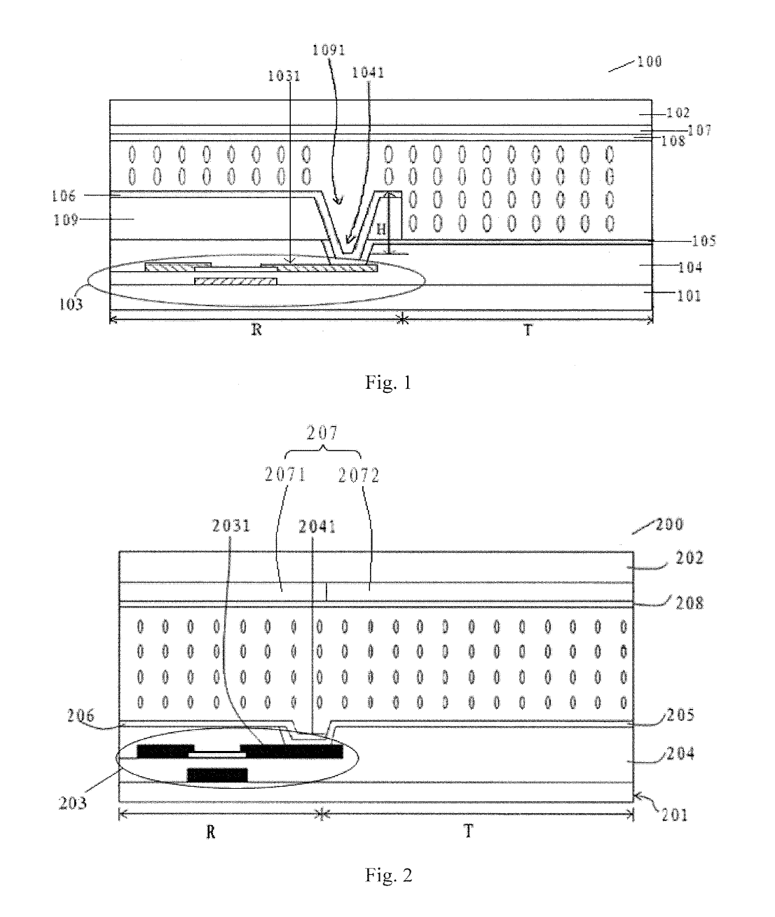

Embodiments will now be described with reference to FIGS. 1 through 23, which relate to a memory device having at least one pre-treated surface for better adhesion of ink on the surface. It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

The terms “top,” “bottom,” “upper,” “lower,” “vertical” and/or “horizontal” as may be used herein are for convenience and illustrative purposes only, and are not meant to limit the description of the invention inasmuch as the referenced item can be exchanged in position.

The embodiments of the present disclosure provides a transflective LCD panel which can avoid light leakage due to the non-uniform alignment of liquid crystal molecules in the transflective LCD panel, thereby improving the product quality.

The embodiment according to the present disclosure provides a transflective LCD panel 200 which includes a first transparent substrate 201 and a second transparent substrate 202 opposing each other, and a liquid crystal layer provided between the first transparent substrate 201 and the second transparent substrate 202.

In the transflective LCD panel according to the embodiments of the present disclosure, the first transparent substrate may correspond to an array substrate, while the second transparent substrate may correspond to a counter substrate. The first transparent substrate may include a plurality of gate lines and a plurality of data lines (not shown) with the gate lines and the data lines intersecting each other to define pixel units arranged in a matrix. Each pixel unit comprises a thin film transistor as a switch element and a pixel electrode for controlling the arrangement of the liquid crystal. In each pixel unit, the gate of the thin film transistor is electrically connected to or formed integrally with the corresponding gate line, the source of the thin film transistor is electrically connected to or formed integrally with the corresponding data line, the drain of the thin film transistor is electrically connected to or formed integrally with the corresponding pixel electrode. The following description is for a single pixel unit; however, other pixel units may be formed in the same manner.

As shown in FIG. 2, in a pixel unit, a thin film transistor 203 and a first insulating layer 204 are formed on the side of the first transparent substrate 201 facing the second transparent substrate 202 with the first insulating layer 204 covering the thin film transistor 203. An ITO transparent electrode layer 205 is formed above a region on one side of the first insulating layer 204; an Al electrode layer 206 is formed above a region on the other side of the first insulating layer 204, with the Al electrode layer 206 and the ITO transparent electrode layer 205 substantially on a same level. As such, in the present embodiment, there is no height difference between the Al electrode layer 206 and the ITO transparent electrode layer 205, thereby there is no non-uniform alignment induced by the alignment film. Consequently, the liquid crystal molecules are oriented uniformly without light leakage.

According to the characteristics of the transflective LCD panel, the pixel unit of the LCD panel is divided into a transmissive region and a reflective region. In the embodiments of the present disclosure, the reflective region R of the LCD panel is defined by the region with the Al electrode layer 206 provided thereon, and the transmissive region T is defined by the region with the ITO transparent electrode layer 205 provided thereon which is not covered by the Al electrode layer 206, as shown in FIG. 2. Since there is no additional second insulating layer provided on the first substrate 201 such as in the conventional transflective LCD panel shown in FIG. 1, the color saturation of the transmissive region T might be different from that of the reflective region R. As such, in the present embodiment, in order to keep an uniform color saturation, a color filter layer 207 comprising a color filter layer part 2071 and a color filter layer part 2072 is provided on the second transparent substrate 202. The color filter layer part 2071 is located in the reflective region R corresponding to the Al electrode layer 206, and the color filter layer part 2072 is located in the transmissive region T corresponding to the ITO transparent electrode layer 205 which is not covered by the Al electrode layer 206. The color filtering ability of the color filter layer part 2071 in the reflective region R is lower than that of the color filter layer part 2072 in the transmissive region T. The color filtering ability is an important factor affecting the color saturation and may be adjusted by the concentration of the pigment in the color filter layer and the transmittance of the color filter layer. Herein the concentration refers to a concentration in weight percentage. As such, the transflective LCD panel 200 according to the embodiments of the present disclosure may avoid light leakage while the color saturation of the transmissive region T and the reflective region R may be kept uniform.

Specifically, the color filtering ability of the color filter layer part 2071 in the reflective region R is made lower than that of the color filtering layer part 2072 corresponding to the transmissive region T by a following method. During the formation of the color filter layer 207, the photoresist coated in the reflective region R is thinner than the photoresist coated in the transmissive region T. The coated photoresist has pigments dispersed therein and can be kept as the color filter layer. Other details of the process are known to the skilled in the art, thus being omitted for simplicity.

In another embodiment of the present disclosure, the color filtering ability of the color filter layer part 2071 in the reflective region R is made lower than that of the color filtering film layer part 2072 in the transmissive region T by another method described as following. During the formation of the color filter layer 207, the pigments concentration in the pigment liquid in the coated photoresist in the reflective region R is lower that in the transmissive region T, with the photoresists kept as the color filter layer. The pigment concentration is one of the main factors determining the color saturation. In order to keep pigments stable in the resin and the solvent in order to form the pigment liquid, the pigment liquid also includes dispersant. The dispersant in the pigment liquid is for separating the pigment particles, so as to avoid agglomeration and sedimentation. Furthermore, there is certain concentration ratio among components such as the pigments, resin and dispersant in the pigment liquid. In other words, a concentration change of any of the three components may cause concentration changes of the other two components in order to form a stable pigment liquid, otherwise the pigment liquid might be unstable. As such, while the concentration of the pigment in the coated photoresist in the reflective region R is lower than that in the transmissive region T, the concentrations of the resin and the dispersant in the pigment liquid of the photoresist for forming the color filter layer part 2071 in the reflective region R are also lower than those of the resin and the dispersant in the pigment liquid of the photoresist for forming the color filter layer part 2072 in the transmissive region T, such that the concentration of the pigment as well as the concentrations of the resin and the dispersant are decreased simultaneously so as to form a stable pigment liquid.

In this case, the materials are saved, and the transmittance of the reflective region as well as the contrast of LCD is increased due to the decreased concentrations of the resin and the dispersant in the photoresist.

Optionally, the pigment concentration in the pigment liquid employed in the photoresist of the reflective region R is in a range of 6% to 8%, while the pigment concentration in the pigment liquid employed in the photoresist of the transmittance region T is in a range of 12% to 15%.

It is noted that in the present embodiment, a contact hole 2041 is provided on the first insulating layer 204, and exposes a part of the drain 2031 of the thin film transistor 203. At one end of the contact hole 2041, the ITO transparent electrode layer 205 formed above one side of the first insulating layer 204 covers part of the drain 2031 of the thin film transistor 203, that is, the ITO transparent electrode layer 205 is electrically connected to the drain 2031 through the contact hole 2041. At the other end of contact hole 2041, the Al electrode layer 206 formed above the other side of the first insulating layer 204 covers the ITO transparent electrode layer 205 at the contact hole 2041, that is, the Al electrode layer 206 is electrically connected to the ITO transparent electrode layer 205 through the contact hole 2041.

In addition, there may be a common electrode layer 208 formed on the color filter layer 207 provided on the second transparent substrate 202, resulting in a voltage difference between the Al electrode layer 206, the ITO transparent electrode layer 205 and the common electrode layer 208 upon operation, thereby controlling the rotation of the liquid crystal molecules.

In the transflective LCD panel according to the embodiments of the present disclosure, an Al electrode layer is formed above the first insulating layer, and the color filtering ability of the color filter layer on the second substrate corresponding to the reflective region is lower than that of the color filter layer on the second substrate corresponding to the transmissive region, the color saturation of the reflective region and the transmissive region is thus kept uniform. In addition, when alignment film is applied on the Al electrode layer and ITO transparent electrode layer, there is no non-uniform alignment due to the height differenced caused by the second insulating film formed above the first insulating film on one side, thus avoiding light leakage and improving product quality.

Herein, “the second element is formed above the first element” refers to that the second element is formed further away from the substrate supporting the first element and the second element than the first element.

The embodiments of the present disclosure provide a display apparatus comprising the transflective LCD panel according to any of the above-mentioned embodiments. The display apparatus according to the embodiments of the present disclosure may be a LCD TV, a cell phone, a LCD, a GPS etc. In some of the exemplary embodiments, the LCD apparatus further comprises a backlight unit for providing back lights to the transflective LCD panel.

According to the descriptions above, embodiments of the present disclosure may at least provide the structures as below:

(1). A transflective LCD panel, comprising: a first transparent substrate and a second transparent substrate opposing each other, and a liquid crystal layer provided between the first transparent substrate and the second transparent substrate, wherein a thin film transistor and a first insulating layer are formed on the side of the first transparent substrate facing the second transparent substrate, and the first insulating layer covers the thin film transistor; a transparent electrode layer and a reflective electrode layer are formed above the first insulating layer, with the reflective layer and the transparent electrode layer substantially on a same level; wherein a color filter layer is provided on the side of the second transparent substrate facing the first transparent substrate, and comprises a first color filter layer and a second color filter layer, the first color filter layer corresponds to the reflective electrode layer and the second color filter layer corresponds to the transparent electrode layer which is overlapped with the reflective electrode layer, and the color filtering ability of the first color filter layer is less than that of the second first color filter layer.

(2). A transflective LCD panel according to (1), wherein the thickness of the first color filter layer is smaller than that of the second color filter layer.

(3). A transflective LCD panel according to (1), wherein the pigment concentration in the first color filter layer is lower than that in the second color filter layer, and the resin concentration and the dispersant concentration in the first color filter layer are also lower that those in the second color filter layer respectively.

(4). A transflective LCD panel according to (3), wherein the first color filter layer is made of a first photoresist with the pigment concentration in the pigment liquid in the first photoresist in the range of 6% to 8%; and the second color filter layer is made of a second photoresist with the pigment concentration in the pigment liquid in the second photoresist in the range of 12% to 15%.

(5). A transflective LCD panel according to (1), wherein a contact hole is provided in the first insulating layer, and the drain of the thin film transistor contacts with the transparent electrode layer at the contact hole.

(6). A transflective LCD panel according to (5), wherein the reflective electrode layer covers a part of the transparent electrode layer in the contact hole.

(7). A transflective LCD panel according to (1), wherein a common electrode layer is formed above the color filter layer.

(8). A transflective LCD panel according to (1), wherein the reflective electrode layer is an Al electrode layer.

(9). A transflective LCD panel according to (1), wherein the reflective electrode layer is an ITO transparent electrode layer.

(10) A display apparatus, comprising the transflective LCD panel according to (1).

What is claimed is:

1. A transflective LCD panel, comprising: a first transparent substrate and a second transparent substrate opposing with each other, and a liquid crystal layer provided between the first transparent substrate and the second transparent substrate,
wherein a thin film transistor and a first insulating layer are formed on the side of the first transparent substrate facing the second transparent substrate, and the first insulating layer covers the thin film transistor; a transparent electrode layer and a reflective electrode layer are formed above the first insulating layer, with the reflective layer and the transparent electrode layer substantially on a same level;
wherein a color filter layer is provided on the side of the second transparent substrate facing the first transparent substrate, and comprises a first color filter layer and a second color filter layer, the first color filter layer corresponds to the reflective electrode layer and the second color filter layer corresponds to the transparent electrode layer which is overlapped with the reflective electrode layer, and the color filtering ability of the first color filter layer is less than that of the second first color filter layer.

2. A transflective LCD panel according to claim 1, wherein the thickness of the first color filter layer is less than that of the second color filter layer.

3. A transflective LCD panel according to claim 1, wherein the pigment concentration in the first color filter layer is lower than that in the second color filter layer, and the resin concentration and the dispersant concentration in the first color filter layer are lower that those in the second color filter layer respectively.

4. A transflective LCD panel according to claim 3, wherein the first color filter layer is made of a first photoresist with a pigment concentration in the pigment liquid in the first photoresist in the range of 6% to 8%; and the second color filter layer is made of a second photoresist with a pigment concentration in the pigment liquid in the second photoresist in the range of 12% to 15%.

5. A transflective LCD panel according to claim 1, wherein a contact hole is provided in the first insulating layer, and the drain of the thin film transistor contacts with the transparent electrode layer at the contact hole.

6. A transflective LCD panel according to claim 5, wherein the reflective electrode layer covers a part of the transparent electrode layer in the contact hole.

7. A transflective LCD panel according to claim 1, wherein a common electrode layer is formed above the color filter layer.

8. A transflective LCD panel according to claim 1, wherein the reflective electrode layer is an Al electrode layer.

9. A transflective LCD panel according to claim 1, wherein the transparent electrode layer is an ITO transparent electrode layer.

10. A liquid crystal display device, comprising the transflective LCD panel according to claim 1.
